(19) United States
(12) Patent Application Publication
(10) Pub. No.: US 2026/0039403 A1
(43) Pub. Date: Feb. 5, 2026

(54) DETECTION AND MITIGATION OF ATMOSPHERIC DUCTING IN 4G AND 5G NETWORKS

(71) Applicant: T-MOBILE INNOVATIONS LLC, Overland Park, KS (US)

(72) Inventors: Rommel John Gatan Gammad, Elgin, IL (US); Mohammed Riazuddin Hasan Nizami, Bartlett, IL (US); Rongjie Ji, Lisle, IL (US)

(21) Appl. No.: 18/789,777

(22) Filed: Jul. 31, 2024

(51) Int. Cl. H04B 17/336; H04B 17/382; H04J 11/00

(52) U.S. Cl. CPC H04B 17/336; H04B 17/382; H04J 11/0056

(57) ABSTRACT

Systems, methods, and devices are disclosed herein for detecting, classifying, and mitigating the effects of atmospheric ducting in wireless communications networks. At least one received interference power (RIP) value collected at a base station of a wireless communication network is received. A ducting intensity is then identified by comparing the at least one RIP value collected at the base station to a baseline RIP value. The ducting intensity is further compared with at least one threshold to determine whether to apply ducting mitigation parameters in the wireless communication network. If the ducting intensity exceeds the at least one threshold, at least one ducting mitigation strategy is applied in the wireless communication network.

### TECHNICAL FIELD

Various embodiments of the present technology relate to wireless communication networks and in particular to accurately detecting and mitigating the effects of atmospheric ducting in wireless communication networks.

### BACKGROUND

Ducting is a phenomenon that affects the propagation of radio waves and how signals travel through the atmosphere. Atmospheric ducting occurs when radio waves are trapped in a layer of the atmosphere, such as the troposphere, typically due to variations in temperature and/or humidity that cause changes in the refractive index of the air. These temperature and humidity variations can create ducts that guide the radio waves over long distances with less attenuation than would otherwise occur. Tropospheric ducting is a type of atmospheric ducting that specifically occurs in the troposphere, the lowest layer of the Earth's atmosphere.

In 4G and 5G communication networks, atmospheric ducting can cause several issues that ultimately degrade the user experience. Ducting can cause signals to travel far beyond their intended range, causing unintended coverage and interference with distance cells operating on the same or adjacent frequencies, potentially leading to cross-border interference issues. The extended propagation can also result in co-channel and adjacent channel interference, degradation of signal quality and an increase in bit error rates. The multipath effects caused by ducting can also distort signals, reducing their quality and reliability. These issues can significantly impact network performance due to reduced throughput, increased call drop rates, and higher latency.

Current network management systems lack the ability to effectively detect atmospheric ducting conditions in real-time or near real-time and implement the necessary adjustments. By improving techniques for detecting and mitigating the effects of atmospheric ducting, network operators can enhance the reliability and quality of service in 4G and 5G networks, ensuring a better user experience and more efficient use of network resources.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to improving the user experience in wireless communication networks. More specifically, the technology disclosed herein includes systems and methods for detecting and mitigating the effects of atmospheric ducting in wireless communication networks. In a first embodiment, a method of operating a wireless communication network includes receiving at least one received interference power (RIP) value collected at a base station of the wireless communication network, identifying a ducting intensity by comparing the RIP value collected at the base station to a baseline RIP value, comparing the ducting intensity with at least one threshold to determine whether to apply ducting mitigation parameters in the wireless communication network, and, if the ducting intensity exceeds the at least one threshold, applying at least one ducting mitigation strategy in the wireless communication network.

The RIP value, in some embodiments, is a cell average uplink RIP value collected as one of several other KPIs collected on the base station. In some examples, the base station may receive one RIP value for each physical resource block (PRB) in a frequency band of the wireless communication network. The frequency band, in some examples, is the n41 (2496-2690 MHZ) band of a Fifth Generation (5G) cellular communication network and one RIP value is collected and received for every PRB in a 100 megahertz (MHz) bandwidth of the n41 band. The method, in some embodiments, further includes aggregating each RIP value for each PRB of the plurality of PRBs into two or more aggregated values, where each aggregated value is an average of two or more RIP values. The aggregated values may be compared to the baseline RIP value to identify the ducting intensity. In some implementations, applying the at least one ducting mitigation strategy includes modifying at least one parameter that affects which frequency band user equipment uses to connect to the base station. The method further includes, in some examples, classifying the ducting intensity into one of two or more classifications based at least in part on the ducting intensity and the at least one RIP value, wherein each classification is associated with a different ducting mitigation strategy. Applying the at least one ducting mitigation strategy may therefore include applying one of the ducting mitigation strategies.

In an alternative embodiment, one or more non-transitory computer-readable storage media have program instructions stored thereon. The program instructions, when executed by a computing system, direct the computing system to perform operations. The operations include receiving at least one received interference power (RIP) value collected at a base station of a wireless communication network, identifying a ducting intensity by comparing the RIP value collected at the base station to a baseline RIP value, comparing the ducting intensity with at least one threshold to determine whether to apply ducting mitigation parameters in the wireless communication network, and, if the ducting intensity exceeds the at least one threshold, applying at least one ducting mitigation strategy in the wireless communication network.

In yet another embodiment, a system includes one or more computer-readable storage media, a processing system operatively coupled with the one or more computer-readable storage media, and program instructions stored on the one or more computer-readable storage media. The program instructions, when read and executed by the processing system, direct the processing system to at least: receive at least one received interference power (RIP) value collected at a base station of a wireless communication network, identify a ducting intensity by comparing the RIP value collected at the base station to a baseline RIP value, compare the ducting intensity with at least one threshold to determine whether to apply ducting mitigation parameters in the wireless communication network, and, if the ducting intensity exceeds the at least one threshold, apply at least one ducting mitigation strategy in the wireless communication network.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communication network to in accordance with some embodiments of the present technology;

FIG. 2 illustrates the atmospheric ducting phenomenon in a wireless communication network in accordance with some embodiments of the present technology;

FIG. 3 illustrates an example of a wireless communication network infrastructure in accordance with some embodiments of the present technology;

FIG. 4 illustrates a graph containing RIP values and mitigation strategies associated with varying ducting intensities in accordance with some embodiments of the present technology;

FIG. 5 is a flowchart illustrating a series of steps performed in a wireless communication network in accordance with some embodiments of the present technology;

FIG. 6 is a flowchart illustrating a series of steps performed in a wireless communication network in accordance with some embodiments of the present technology;

FIG. 7 illustrates a 5G wireless communication network according to one or more embodiments of the present technology; and

FIG. 8 illustrates a computing system suitable for implementing the various operational environments, architectures, processes, scenarios, and sequences discussed below with respect to the other Figures.

### DETAILED DESCRIPTION

Systems, methods, and devices are disclosed herein for detecting, classifying, and mitigating the effects of atmospheric ducting in wireless communication networks. Examples of such wireless communication networks may include 4G and 5G communication networks. More specifically, the technology disclosed herein leverages a specific key performance indicator (KPI) collected by base stations (e.g., 4G and 5G base stations)—Received Interference Power—to accurately detect when ducting is occurring. In some examples, the received interference power (RIP) KPI is, more specifically, the cell average uplink received interference power across all physical resource blocks (PRBs) of the entire 100 MHz bandwidth of the n41 band. Once ducting is detected via the RIP KPI, systems and methods are disclosed herein for classifying the ducting intensity and mitigating the effects based on the ducting intensity.

Atmospheric ducting is a phenomenon that affects the propagation of radio waves and influences how signals travel through the atmosphere. Ducting occurs when radio waves become trapped in atmospheric layers, such as the troposphere, due to variations in temperature and/or humidity that alter the refractive index of the air. These variations can create ducts that guide radio waves over long distances with less attenuation than would otherwise occur. Tropospheric ducting is a type of atmospheric ducting that specifically takes place in the troposphere, the lowest layer of the Earth's atmosphere.

In wireless communication networks, atmospheric ducting can cause significant issues that degrade the user experience. The phenomenon can cause signals emitted by an access node, e.g., a base station, of a cell to travel far beyond their intended range, leading to unintended coverage and interference with distant cells operating on the same or adjacent frequencies, potentially causing cross-border interference. Each cell is a particular geographical area that is serviced by a corresponding access node, e.g., base station, of a wireless communication network. Extended signal propagation can also result in co-channel and adjacent channel interference, signal quality degradation, and increased bit error rates. The multipath effects from ducting can distort signals, reducing their quality and reliability. These issues can severely impact network performance, resulting in reduced throughput, higher call drop rates, and increased latency.

The n41 band, with its frequency range of about 2496 MHz to 2690 MHz, is particularly susceptible to atmospheric ducting. Mid-band frequencies like the n41 band can be more affected by changes in the atmospheric refractive index caused by temperature inversions and humidity gradients. Thus, many examples of the technology disclosed herein are given in the context of the n41 band. However, it should be understood that the systems and methods of ducting detection and mitigation apply to any frequency band that operates in a similar manner to the n41 band, including low-frequency bands, mid-frequency bands, and high-frequency bands.

Current network management systems are unable to effectively detect atmospheric ducting conditions in real-time or near real-time and make necessary adjustments. One issue with detecting ducting conditions is finding which KPIs potentially correspond to atmospheric ducting. Finding the right measurements that could be used to identify ducting is challenging because atmospheric ducting can mimic or coincide with other network issues, making it difficult to isolate its specific impact. KPIs such as signal strength (RSRP), signal quality (RSRQ), interference levels, and bit error rates can all be affected by a variety of factors, including physical obstructions, network congestion, and equipment malfunctions. Atmospheric ducting causes variations in these KPIs by extending signal propagation and increasing interference over longer distances, but these changes can be subtle and sporadic. Additionally, atmospheric conditions that lead to ducting are variable and can change rapidly, complicating the correlation between specific KPI anomalies and the presence of ducting.

Because the subtle KPI changes that ducting may cause can be easily confused with network issues, and because traditional monitoring tools lack real-time environmental data and specialized sensors needed to identify and respond to ducting, existing methods of detecting atmospheric ducting are unreliable. Therefore, there is a need for reliable methods for accurately detecting atmospheric ducting in wireless communication networks.

Various technical effects may be appreciated from the implementations disclosed herein. Such technical effects that result from accurate detection and mitigation of atmospheric ducting include the adjustment of network parameters in a timely manner, improved signal quality, reduced interference, and enhanced overall network performance. Consequently, the technology disclosed herein ensures more reliable connectivity, higher data throughput, and lower latency, thereby enhancing the user experience. The improved detection and mitigation strategies discussed herein also help optimize resource allocation and reduce the likelihood of cross-border interference, leading to more efficient and effective network management.

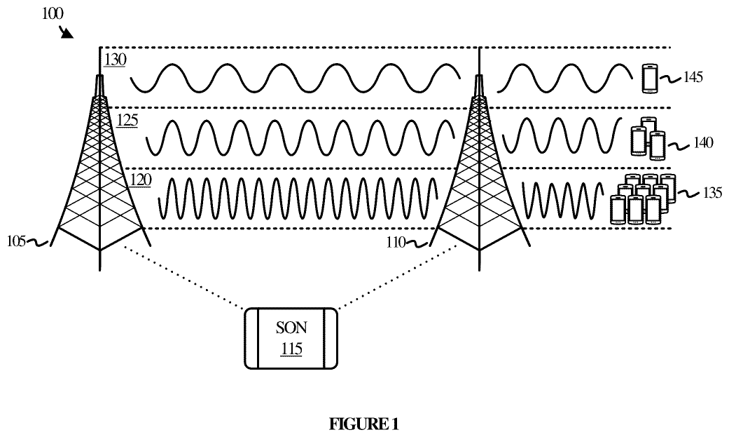

FIG. 1 illustrates access network 100, which is representative of the radio access portion of a wireless communication network infrastructure in which atmospheric ducting is detected and mitigated in accordance with embodiments of the present technology. Access network 100 delivers services like voice calling, machine communications, internet access, media streaming, or some other wireless/wireline communication product that may be provided to user devices. Access network 100 includes base station 105, base station 110, self-organizing network (SON) module 115, high-frequency band 120, mid-frequency band 125, low-frequency band 130, user equipment (UE) 135, user equipment (UE) 140, and user equipment (UE) 145. In other examples, access network 100 may include additional or different elements than those illustrated in FIG. 1.

UE 135, UE 140, and UE 145 are representative of wireless/wireline user devices. Exemplary user devices include phones, smartphones, computers, vehicles, drones, robots, sensors, and/or other devices with wireless communication capabilities. Access network 100 exchanges wireless signals with UE 135, UE 140, and UE 145 over radio frequency bands including high-frequency band 120, mid-frequency band 125, and low-frequency band 130. The radio frequency bands use wireless network protocols like Fifth Generation (5G) New Radio (NR), Long Term Evolution (LTE), Institute of Electrical and Electronic Engineers (IEEE) 802.11 (WIFI), and Low-Power Wide Area Network (LP-WAN). Access network 100 is connected to other components of a wireless communication network over backhaul data links. Access network 100 exchanges network signaling and user data with other network elements in the broader communication network.

Access network 100 may include wireless access nodes (e.g., base station 105 and base station 110), internet backbone providers, edge computing systems, or other types of wireless/wireline access systems to provide wireless links to UE 135, UE 140, and UE 145, backhaul links to components of the core network, and edge computing services between the user devices and core network. The wireless access nodes (e.g., base station 105 and base station 110) of access network 100 may include Fifth Generation (5G) RANs, LTE RANS, gNodeBs, eNodeBs, NB-IoT access nodes, LP-WAN base stations, wireless relays, WIFI hotspots, Bluetooth access nodes, and/or other types of wireless or wireline network transceivers. The access nodes may include Radio Units (RUs), Distributed Units (DUs), and/or Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers closer to the core network. The CUs handle higher wireless network layers like the Radio Resource Control (RRC), Service Data Adaption Protocol (SDAP), and Packet Data Convergence Protocol (PDCP). The CUs are coupled to network functions in the core network.

Access network 100 may serve a core network, such as a 4G and/or 5G core network, in some examples, which includes computing systems that provide wireless data services to user devices over access network 100. Exemplary computing systems comprise data centers, server farms, network function virtualization infrastructure (NFVI), cloud computing networks, hybrid cloud networks, and the like. The computing systems store and execute the network functions to provide wireless data services to UE 135, UE 140, and UE 145 over access network 100. The computing systems in the core network typically store and execute network functions to form a control plane and a user plane to serve UE 135, UE 140, UE 145, and other user equipment. The control plane may include network functions such as an access and mobility management function (AMF), session management function (SMF), a policy control function (PCF), unified data management (UDM), and/or a home subscriber server (HSS). The user plane may include network functions like user plane function (UPF). The core network may include Fifth Generation Core (5GC) architecture, an Evolved Packet Core (EPC) architecture, or the like.

Base station 105 and base station 110 can take different forms depending on the network technology they support, such as an eNodeB (Evolved Node B) in a 4G network or a gNodeB (gNB) in a 5G network. Base station 105 and base station 110 may each support multiple technologies, allowing them each to function as both an eNodeB and a gNodeB. In some deployments, however, separate physical base stations might be used for 4G and 5G. A radio access network (RAN), such as access network 100, may include both gNodeBs for 5G NR and eNodeBs for 4G LTE, working together in a non-standalone (NSA) configuration to provide seamless connectivity and transition between 4G and 5G services.

In the example of FIG. 1, base station 105 and base station 110 utilize high-frequency band 120, mid-frequency band 125, and low-frequency band 130 to achieve a balance between coverage, capacity, and performance in the communications network they serve. Low-frequency band 130, in some examples, operates on frequencies between 600 MHz and 2 GHZ. Low-frequency band 130 provides broad coverage and effective penetration through building and other obstacles. Low-frequency band 130, in the example of FIG. 1, is serving UE 145, the lowest number of user devices due to its limited bandwidth. Mid-frequency band 125, in some examples, operates on frequencies between 1 GHz and 6 GHz. Mid-frequency band 125 provides faster data speeds and supports higher traffic volumes than low-frequency band 130. Thus, mid-frequency band 125, in the example of FIG. 1, is serving UE 140, a larger number of user devices than UE 145. High-frequency band 120, in some examples, operates on frequencies between 24 GHz and 100 GHz. High-frequency band 120 provides the highest data rates and user capacity but has the most limited range and penetration ability compared to mid-frequency band 125 and low-frequency band 130. High-frequency band 120 is serving UE 135, which includes the highest number of user devices due to the extensive bandwidth capabilities of the band. High-frequency band 120 offers the greatest bandwidth because of the much wider range of available frequencies it offers compared to mid-frequency band 125 and low-frequency band 130. This expansive bandwidth allows for higher data rates and the capacity to support a large number of simultaneous connections.

Each of high-frequency band 120, mid-frequency band 125, and low-frequency band 130 in access network 100 may be shared between 4G and 5G technologies, in some implementations. Mid-frequency band 125, for example, may share usage between 4G LTE networks and 5G NR networks. Low-frequency band 130 may also serve dual roles in 4G and 5G networks, such as on the 700 MHz and 800 MHz bands that are commonly used in 4G and 5G networks to ensure good coverage and connectivity, especially in rural or hard-to-reach areas. High-frequency band 120, though most commonly used in the context of 5G, can also support 4G technologies.

In some cases, each of high-frequency band 120, mid-frequency band 125, and low-frequency band 130 may serve several different operational frequency bands. For example, mid-frequency band 125 may serve a multitude of distinct operational bands including but not limited to band n41 (2500 MHZ), band n78 (3400 MHZ), and band n77 (3700 MHZ). Low-frequency band 130 may serve a multitude of distinct operational bands including but not limited to band n71 (600 MHZ), band n5 (850 MHZ), band n66 (1700/2100 MHZ), and band n2 (1900 MHZ). High-frequency band 120 may also serve a multitude of distinct frequency bands including but not limited to band n58 (24 GHZ), band n261 (28 GHZ), band n260 (39 GHz), and band n262 (47 GHz).

Users on access network 100 may be distributed across different frequency bands for a variety of reasons to optimize network performance and user experience. This distribution is managed by the network's resource allocation system (e.g., SON module 115), which considers factors such as user location, device capability, current network load, and specific service requirements. For instance, users in densely populated urban areas may be assigned to high-capacity mid-band frequencies like n41 or n77 to handle large volumes of data traffic, while users in rural or indoor environments may be connected to lower frequency bands like n2, which provide better coverage and penetration through obstructions. Additionally, to balance the load and prevent congestion, the network may dynamically switch users between bands, ensuring that no single band becomes overwhelmed. This strategic allocation and management of users across different bands can help in maintaining high data speeds, reducing latency, and providing a seamless and reliable network experience for all users.

During operation, KPIs are collected on base station 105 and base station 110 to monitor and optimize the performance of access network 100. These metrics provide essential insights into various aspects of network operations, such as signal strength, data throughput, latency, interference levels, call drop rates, and user experience. The base stations may collect KPIs continuously and in real-time using integrated monitoring tools and software that track network conditions and user activities. Thus, base station 105 and base station 110 may include integrated monitoring and measurement tools, such as specialized software and sensors embedded in the base station hardware, which track and report the various metric performance metrics to centralized network management systems (e.g., SON module 115). This data may then be aggregated and analyzed by network management systems, including SON module 115, to identify trends, detect anomalies, and make informed decisions. By collecting and analyzing KPIs, network operators can proactively address issues, balance network load, enhance coverage, manage interference, and ensure optimal quality of service for users. This continuous feedback loop is crucial for maintaining the reliability, efficiency, and performance of modern communication networks.

SON module 115 leverages the KPIs collected from base station 105 and base station 110 to perform its optimization and management roles effectively. SON module 115 can dynamically adjust various network parameters and settings to influence which users and how many users are allocated to different frequency bands. For example, if KPIs collected on base station 105 and/or base station 110 indicate high levels of interference or congestion on a particular frequency band (e.g., band n41), SON module 115 can automatically adjust network parameters to redistribute users to other bands (e.g., band n2 or n77) that are less congested or have better signal quality. KPIs related to user experience, such as throughput and latency, are used by SON module 115 to dynamically adjust network parameters like transmission power, antenna tilt, and resource allocation to enhance service quality. SON module 115 may adjust power levels of base station to extend or shrink cell coverage areas, thereby redistributing users across the network. SON module 115 may also utilize the KPIs to assist in the management of handovers and create seamless transitions for users moving between cells or frequency bands. In addition to SON module 115, other network resources such as traditional network management systems, real-time monitoring tools, and advanced analytics platforms may also be utilized to ensure comprehensive network optimization and performance management.

Access network 100 is an example of an environment in which elements of the ducting detecting and mitigation technology may be implemented. One of the many KPIs received at base station 105 and/or base station 110 includes received interference power. More specifically, the cell average uplink received interference power metric is collected. Other metrics related to received interference power may be collected at base station 105 and/or base station 110 as well. Received interference power measures the amount of interference power received from various sources, such as user equipment within the cell or from neighboring cells operating on the same or adjacent frequencies (e.g., UE 135, UE 140, and/or UE 145). Uplink received interference power specifically corresponds to the amount of interference power received on the uplink (i.e., transmission from a user device to a base station) from such sources. The received interference power KPI corresponds to the level of interference affecting a base station's ability to receive clear signals from its UEs, impacting overall network performance, data throughput, and signal quality. However, as disclosed herein, the uplink received interference power can also be used to detect atmospheric ducting. Received interference power may be collected in or converted to the unit dBm (i.e., decibels relative to one milliwatt).

In embodiments disclosed herein, the cell average uplink received interference power KPI (e.g., “CELL_AVG_UL_RIP_SCHED_PRB0”) is collected for each physical resource block (PRB) of a cell and used to identify when ducting is occurring in access network 100. Within a cell, the available radio spectrum is divided into smaller units called PRBs. A PRB is the smallest unit of frequency-time resources allocated to users in LTE and 5G networks. In one example, the n41 band is divided into 273 PRBs (i.e., PRB0 to PRB272) that make up the full bandwidth (e.g., 100 MHZ) of the n41 band. Thus, one cell average uplink RIP value is received for each of the 273 PRBs in the n41 band.

In some embodiments, the RIP values may be used or averaged individually to detect ducting. However, in an exemplary embodiment of the present technology, the counters corresponding to each PRB are aggregated into groups to reduce computing power. For example, the RIP values received may be grouped into five aggregated metrics that altogether cover the full bandwidth of the PRBs. In a 100 MHz bandwidth, each aggregated metric may include 20 MHz of bandwidth. An example of how the values for each PRB are aggregated into five groups covering the 100 MHz bandwidth may be (1) PRB0-PRB49, (2) PRB50-PRB104, (3) PRB105-PRB161, (4) PRB162-PRB 216, and (5) PRB217-PRB272. The PRB bandwidth may be aggregated differently in other examples, aggregated into a single group, or not aggregated at all. The classification and mitigation steps that follow may therefore be based on the aggregated metrics, rather than the 273 individual values, in certain embodiments.

In some examples, KPIs such as the received interference power are reported at regular intervals (e.g., every 15 minutes) to SON module 115. Thus, the average uplink received interference power metric as discussed herein may be an average value over the most recent regular interval (e.g., the average over the last 15 minute interval).

Once the RIP values are collected and aggregated, a ducting module of SON module 115 uses the RIP data to determine the ducting intensity and implement any mitigation strategies based on the intensity. To determine the ducting intensity, the ducting module of SON module 115 compares the aggregated RIP values to a baseline RIP value to get a RIP delta value (i.e., the difference between the aggregated RIP value and the baseline RIP value). The baseline RIP value is an RIP value collected on a day when no ducting was occurring. The baseline RIP value may be a single value with which all RIP values get compared, or may be time-based, such that the baseline value corresponds to a ducting-free RIP at the same or similar time of day to the most recent RIP value collected. The SON module 115 ducting module, in some embodiments, is a single instance that performs ducting detection and mitigation for both NR and LTE networks, thereby limiting the compute resources necessary for the methods disclosed herein.

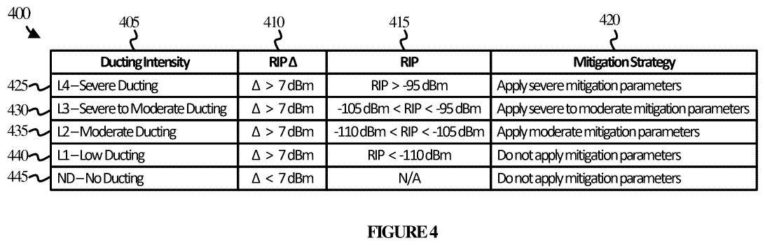

After calculating the RIP delta value, the SON module 115 ducting module classifies the ducting intensity in a two-part classification method. The first part of the classification method is comparing the RIP delta value to a fixed threshold (e.g., 7 dBm). If the RIP delta value is greater than the fixed threshold, then the absolute RIP value is classified into one of several ducting intensity classes (e.g., severe ducting, moderate ducting, and low ducting) by comparing it to fixed, configurable thresholds or ranges associated with each classification. If the RIP delta value is less than the threshold, it is assumed that no ducting mitigation is necessary. A more detailed example of how the ducting intensities may be broken into different classifications based on the RIP delta and absolute RIP is discussed in reference to FIG. 4.

Once the ducting intensity is determined, ducting mitigation strategies may be implemented based on the intensity. In an embodiment in which the ducting intensity is classified as described above, the mitigation strategies may be applied based on the found classification. However, the mitigation strategies discussed herein may be implemented based on the ducting intensity alone, rather than on a classification system.

If the ducting module of SON module 115 determines that the ducting intensity is above a threshold, SON module 115 applies appropriate parameters and/or settings in the network. In an example in which the ducting intensity was classified into a fixed class, mitigation parameters may be applied based on that class such that any time the intensity falls into that category the same mitigation parameters are applied. Alternatively, mitigation parameters may be based on the absolute RIP value(s) or RIP delta value(s) rather than a classification system, such as on a sliding scale of adjustment. As previously described, SON module 115 can dynamically adjust various network parameters and settings to influence which users and how many users are allocated to different frequency bands. Thus, SON module 115 may adjust settings or parameters that limit initial access to certain bands affected by ducting (e.g., via qRxLevmin and B1 thresholds), limit incoming traffic to certain bands (e.g., via Pcell swaps and A4 handovers), or release existing customers from certain bands (e.g., A2 redirect and release). In the example of the n41 band, SON module 115 may shift 5G customers from the n41 (2500 MHZ) band to other 5G bands such as the n2 (1900 MHZ) band or the n71 (600 MHz) band. Although these other bands may have limited bandwidth compared to the n41 band, they may still provide an improved customer experience compared to the n41 band when it is affected by ducting.

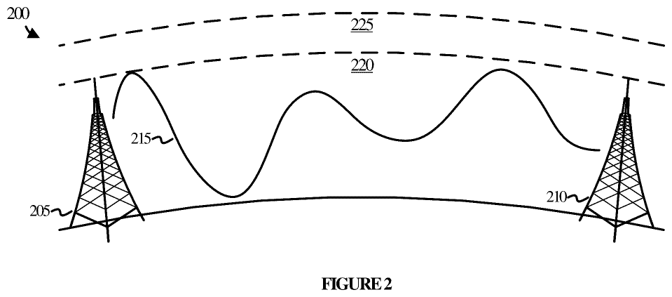

FIG. 2 illustrates access network 200, which is representative of the radio access portion of a wireless communication network infrastructure in which atmospheric ducting is detected and mitigated in accordance with embodiments of the present technology. Access network 200 is experiencing tropospheric ducting in the example of FIG. 2. FIG. 2 includes base station tower 205, base station tower 210, radio signal 215, atmospheric layer 220, and atmospheric layer 225.

Base station tower 205 is shown transmitting radio signal 215. Radio signal 215 travels through the atmosphere and encounters a temperature inversion between atmospheric layer 220 and atmospheric layer 225. Atmospheric layer 220 is situated below the warmer layer, atmospheric layer 225, creating conditions that trap radio signal 215 within the duct formed by these atmospheric layers.

Radio signal 215 begins as a healthy, stable transmission from base station tower 205, intended to propagate normally through the atmosphere. However, as it ascends, it encounters the temperature inversion between atmospheric layer 220 and atmospheric layer 225, which causes a significant change in the refractive index of the air. As radio signal 215 propagates, it follows a path guided by atmospheric layer 220, causing it to travel over a significantly extended distance with minimal attenuation. Radio signal 215 experiences multiple reflections within the duct, demonstrating the characteristic wavelike path indicative of tropospheric ducting. Repeated reflections within the duct can degrade the signal quality, introduce delays, and lead to interference with other signals as it reaches base station tower 210.

The phenomenon depicted in FIG. 2 illustrates how temperature inversions can create ducts that facilitate the long-distance travel of radio signals, which would otherwise dissipate more quickly in a standard atmospheric environment. This ducting effect can significantly impact network performance by causing unexpected coverage areas and potential interference between base stations.

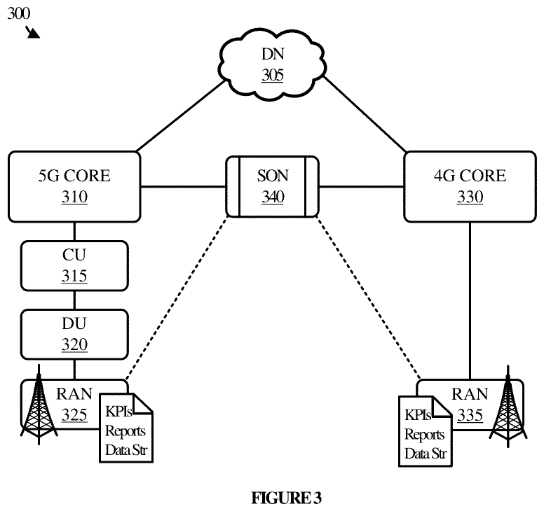

FIG. 3 illustrates wireless communication network 300, an example of a wireless communication network designed to manage and optimize communication systems (e.g., 4G and 5G) using a Self-Organizing Network (SON) module in accordance with some embodiments of the present technology. Wireless communication network 300 includes data network (DN) 305, 5G Core 310, central unit (CU) 315, distributed unit (DU) 320, RAN 325, 4G Core 330, RAN 335, and SON module 340. The elements shown in FIG. 3 are exemplary and illustrative of one possible network architecture configuration. Other embodiments could include different elements, omit some elements, or incorporate additional components not depicted. Variations in the design and implementation of network architectures are possible to meet specific requirements or optimize performance for different operational environments.

Wireless communication network 300 includes DN 305, which interfaces with both 5G core 310 and 4G core 330. DN 305 represents external networks and services that the 4G and 5G networks connect to, facilitating broader data exchanges and supporting a wide range of applications and services. 5G core 310 and 4G core 330 represent the central management entities for their respective network technologies. 5G core 310 is linked to two subcomponents: CU 315 and DU 320. CU 315 manages higher-layer functions of the 5G network, such as control plane operations, while DU 320 handles lower-layer functions, including data plane operations. Together, CU 315 and DU 320 facilitate efficient data transmission and processing within wireless communication network 300.

DU 320 is connected to RAN 325, which is responsible for managing wireless communications between user devices and the 5G network. RAN 325 continuously monitors network performance and collects KPIs, reports, and data streams. Similarly, 4G core 330 is operatively connected to RAN 335, which manages wireless communications within the 4G network. 4G RAN 335 also collects KPIs (including RIP), reports, and data streams, providing a flow of performance data to SON module 340. This data allows SON module 340 to optimize and control the 4G network in parallel with the 5G network. RAN 325 and RAN 335 might include some of the same base station towers equipped to handle both 4G and 5G communications.

Wireless communication network 300 also includes SON module 340, which functions as a hub for network optimization. SON module 340 is responsible for collecting, analyzing, and responding to key performance indicators (KPIs), reports, and data streams from both 4G and 5G RANs. SON module 340 makes adjustments to optimize network performance, improve user experience, and ensure efficient resource utilization.

In accordance with the technology disclosed herein, wireless communication network 300 includes systems for detecting and mitigating the effects of ducting on 4G and 5G networks. To detect and mitigate ducting in wireless communication network 300, RAN 325 and RAN 335 provide KPIs, reports, and similar data streams to SON module 340. One KPI provided to SON module 340 is the uplink received interference power. SON module 340 uses the one or more uplink received interference power values to determine if ducting is affecting the network. To determine if ducting is affecting the network, SON module 340 calculates an RIP delta value by comparing the current RIP value(s) to a baseline RIP value. If the RIP delta is large enough, SON module 340 compares the absolute RIP value(s) to one or more thresholds to determine the ducting intensity. Once the ducting intensity is found, SON module 340 applies one or more mitigation strategies based on the ducting intensity. The mitigation strategies include adjustments to settings and/or parameters in the network to shift users away from any bands affected by ducting onto other bands that are not affected or less affected by ducting.

FIG. 4 illustrates table 400. Table 400 an example of how ducting intensity may be classified and mitigated in a wireless communication network in accordance with some embodiments of the present technology. Table 400 includes four columns-ducting intensity column 405, RIP delta column 410, RIP column 415, and mitigation strategy column 420. Table 400 includes five rows corresponding to ducting intensities-row 425, row 430, row 435, row 440, and row 445. Row 425 corresponds to LA, severe ducting; row 430 corresponds to L3, severe to moderate ducting; row 435 corresponds to L2, moderate ducting; row 440 corresponds to L1, low ducting; and row 445 corresponds to ND, no ducting.

In accordance with the example of FIG. 4, if the RIP (e.g., average uplink received interference power) for a frequency band (e.g., n41 band) is more than 7 dBm greater than the baseline RIP (i.e., RIP delta is greater than 7 dBm), then there is low ducting, moderate ducting, severe to moderate ducting, or severe ducting occurring on the band. If the RIP is less than 7 dBm greater than the baseline RIP, then there is no ducting or negligible ducting occurring. To determine the ducting intensity, however, the absolute RIP value (i.e., the current or more recent value) is compared to the thresholds/ranges in RIP column 415.

Thus, if the RIP delta is greater than 7 dBm and the absolute RIP value is less than-110 dBm, there is low ducting (L1). If the RIP delta is greater than 7 dBm and the absolute RIP value is less than −105 dBm and greater than −110 dBm, there is moderate ducting (L2). If the RIP delta is greater than 7 dBm and the absolute RIP value is less than −95 dBm and greater than −105 dBm, there is severe to moderate ducting (L3). If the RIP delta is greater than 7 dBm and the absolute RIP value is greater than-95 dBm, there is severe ducting (L4).

As previously described, ducting mitigation strategies are applied based on the intensity of the ducting. As shown in FIG. 4, in cases of low ducting (L1), no mitigation parameters are applied, as shown in row 440. In cases of moderate ducting (L2), moderate mitigation parameters are applied, as shown in row 435. In cases of severe to moderate ducting (L3), severe to moderate mitigation parameters are applied, as shown in row 430. In cases of severe ducting (L4), severe mitigation parameters are applied, as shown in row 425.

The numbers, ranges, intensity classifications, and mitigation techniques shown in table 400 are merely exemplary and provided for illustrative purposes. It should be understood that other values, systems, and classifications could be employed without departing from the scope of the contemplated invention. The specific configurations and parameters described in table 400 are not intended to limit the invention, but rather to demonstrate one possible implementation. Variations and modifications in these details are expected and could be tailored to meet different requirements or optimize performance in various operational contexts, all while remaining within the scope of the present disclosure.

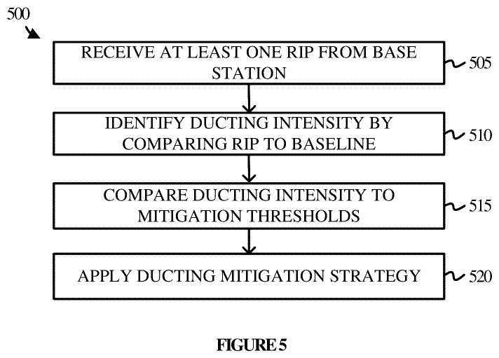

FIG. 5 illustrates process 500. Process 500 is an exemplary operation of detecting and mitigating atmospheric ducting in wireless communication network 300, access network 100, and/or access network 200. The operations may vary in other examples. The operations of process 500, in some examples, are performed by SON module 115 and/or SON module 340.

The operations of process 500 include receiving at least one RIP value from a base station in the network (step 505). In the example of FIG. 1, SON module 115 receives a plurality of cell average uplink received interference power values from each of base station 105 and base station 110. The plurality of values may be one value for each PRB or one or more aggregated values. In either case, the at least one RIP value represents the average collected over the last collection interval (e.g., fifteen minutes). In other examples, the at least one RIP value may be a continuous stream collected in real-time by SON module 115.

The operations of process 500 further include identifying a ducting intensity by comparing the at least one received RIP value to a baseline RIP value (step 510). The baseline RIP value is an RIP value collected on a day when no ducting was occurring. The baseline RIP value may be a single value with which all RIP values get compared, or may be time-based, such that the baseline value corresponds to a ducting-free RIP at the same or similar time of day to the most recent RIP value collected.

The operations of process 500 further include comparing the ducting intensity to at least one mitigation threshold (step 515). As previously described, the way that ducting mitigation strategies are applied may differ in accordance with different embodiments of the present disclosure. In some examples, the SON module (e.g., SON module 115 or SON module 340) may compare the ducting intensity to a single configurable threshold to determine whether a ducting mitigation strategy should be on or off. In other examples, such as in the example of FIG. 4, the SON module may compare the ducting intensity to a plurality of configurable thresholds to determine which ducting mitigation strategy is appropriate, if any. Once the ducting mitigation strategy is chosen based on the ducting intensity, the SON module applies the appropriate ducting mitigation strategy by adjusting one or more parameters in the network to affect which frequency bands UEs connect to (step 520).

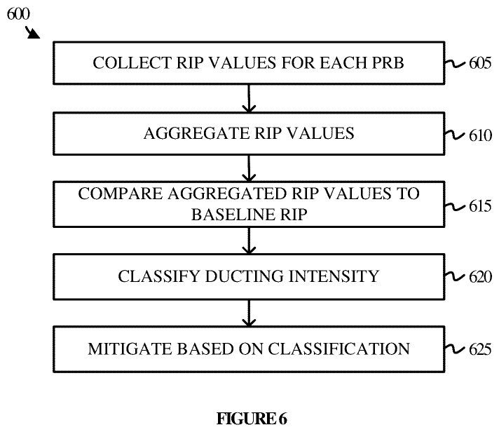

FIG. 6 illustrates process 600. Process 600 is an exemplary operation of detecting, classifying, and mitigating atmospheric ducting in wireless communication network 300, access network 100, and/or access network 200. The operations may vary in other examples. The operations of process 600, in some examples, are performed by SON module 115 and/or SON module 340 from the preceding figures.

The operations of process 600 include collecting RIP values for each PRB (step 605). In the example of FIG. 1, base station 105 collects 273 RIP values for the n41 band during each interval, corresponding to each PRB (0-272) The RIP values, in the example of FIG. 1, are average uplink received interference power values. RIP measures the amount of interference power received from various sources, such as user equipment within the cell or from neighboring cells operating on the same or adjacent frequencies (e.g., UE 135, UE 140, and/or UE 145). Uplink received interference power specifically corresponds to the amount of interference power received on the uplink (i.e., transmission from a user device to a base station) from such sources. The received interference power KPI corresponds to the level of interference affecting a base station's ability to receive clear signals from its UEs, impacting overall network performance, data throughput, and signal quality. However, as disclosed herein, the uplink received interference power can also be used to detect atmospheric ducting. Received interference power may be collected in or converted to dBm (i.e., decibels relative to one milliwatt).

The operations of process 600 further include aggregating the collected RIP values (step 610). For example, the RIP values received may be grouped into five aggregated metrics that altogether cover the full bandwidth of the PRBs. In a 100 MHz bandwidth, each aggregated metric may include 20 MHz of bandwidth. The classification and mitigation steps that follow may therefore be based on the aggregated metrics, rather than the 273 individual values. Step 605 and 610 of process 600, in some examples, are performed on the base station (e.g., base station 105) before the metrics are provided to a SON ducting module (e.g., SON module 115). In other examples, step 610 may be performed by the SON ducting module after receiving the RIP values from the base station.

The operations of process 600 further include comparing the aggregated RIP values to a baseline RIP value (step 615). In the example of FIG. 1, SON module 115 compares the aggregated RIP values to a baseline RIP value to get a RIP delta value (i.e., the difference between the aggregated RIP value and the baseline RIP value). The baseline RIP value is a RIP value collected on a day when no ducting was occurring. The baseline RIP value may be a single value with which all RIP values get compared, or may be time-based, such that the baseline value corresponds to a ducting-free RIP at the same or similar time of day to the most recent RIP value collected. In the example of FIG. 6, each aggregated RIP value is compared to the baseline RIP value to identify ducting on each bandwidth corresponding to the aggregated values.

The operations of process 600 further include classifying the ducting intensity based at least in part on the RIP delta value (step 620). In the example of FIG. 1, SON module 115 classifies the ducting intensity. In some examples, classifying the ducting intensity includes an analysis of both the RIP delta value and the absolute delta value, such as in the example of FIG. 4, wherein the ducting intensity is classified as one of severe ducting (LA), severe to moderate ducting (L3), moderate ducting (L2), low ducting (L1), or no ducting (ND). However, in other examples classifying the ducting intensity may include classifying the intensity into additional categories or into as few as two categories (e.g., ducting or no ducting).

The operations of process 600 further include mitigating the effects of ducting on the user experience based on the classification in step 620 (step 625). In the example of FIG. 1, SON module 115 performs the mitigation by adjusting one or more parameters in the network that affect which frequency bands UEs connect to. For example, if the n41 band is heavily affected by ducting (e.g., L4), SON module 115 may adjust parameters in the network that limit access and incoming traffic on n41 and/or release existing users on n41 to other bands that are less affected or not affected by ducting (e.g., the n2 or n71 band). Once the ducting intensity has decreased, the mitigation parameters may be removed or reduced to allow more users on the affected band once again.

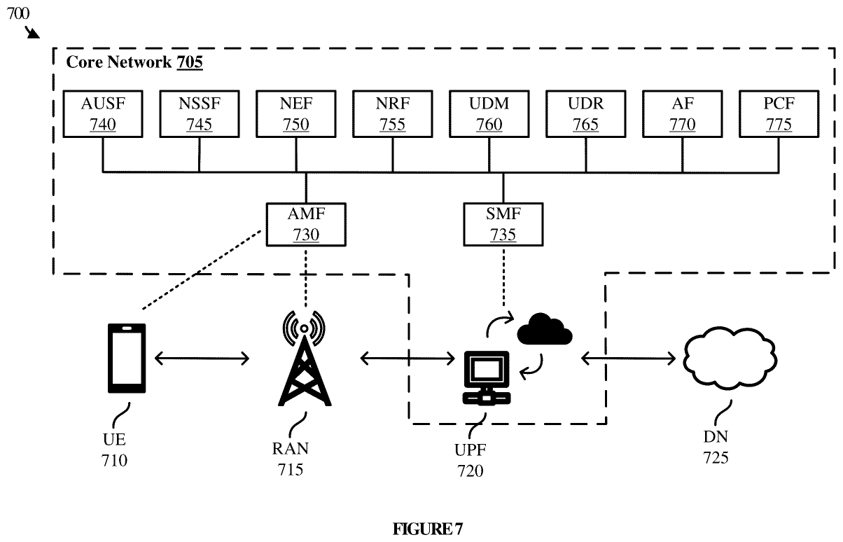

FIG. 7 illustrates 5G communication network 700. 5G communication network 700 is representative of a 5G communication network as disclosed herein in which atmospheric ducting detection, classification, and/or mitigation processes may be implemented. 5G communication network 700 may be representative of wireless communication network 300 illustrated in FIG. 3, in some examples. 5G communication network 700 includes core network 705, user equipment (UE) 710, radio access network (RAN) 715, user plane function (UPF) 720, and data network (DN) 725. Core network 705 includes AMF 730, SMF 735, Authentication Server Function (AUSF) 740, Network Slice Selection Function (NSSF) 745, Network Exposure Function (NEF) 750, Network Repository Function (NRF) 755, Unified Data Management (UDM) 760, Unified Data Repository (UDR) 765, Application Function (AF) 770, and Policy Control Function (PCF) 775. In other examples, 5G communication network 700 may include different or additional elements than those illustrated in FIG. 7 including but not limited to a session communication proxy (SCP), a migration function, a provisioning orchestrator, a CRM client, and the like.

UE 710, in some examples, is representative of UE 135, UE 140, and/or UE 145, from the preceding Figures. RAN 715, in some examples, is representative of access network 100, access network 200, RAN 325, and/or RAN 335 from the preceding Figures. Core network 705, in some examples, is representative of 5G Core 310 from FIG. 3.

AMF 730 is responsible for access and mobility management including the initial registration of devices, authentication, tracking area management, and ensuring that users remain connected as they move through the network. AMF 730 serves as the point of contact for a user device (e.g., UE 710) when it tries to connect to the 5G network (e.g., 5G communication network 700). AMF 730 manages the establishment, maintenance, and termination of the connection between UE 710 and core network 705. SMF 735 is responsible for session management including establishing, modifying, and releasing sessions (which comprise of one or more data flows). SMF 735 also selects and manages the user plane functions, handles aspects of IP address allocation, and maintains the rules for how data should be routed and reported. SMF 735 ensures that data can be successfully transmitted between UE 710 and the internet or other network services.

AUSF 740 is also responsible for aspects of user authentication. AUSF, in part, generates and validates authentication vectors to ensure that the requesting UE is a legitimate subscriber of 5G communication network 700. Upon successful authentication, AUSF 740 contributes to establishing a secure communication channel between UE 710 and core network 705 by facilitating the generation and distribution of security keys. AUSF 740 may also support network slicing by authenticating access to different network slices based on user subscription. AUSF 740 also supports roaming by interacting with corresponding authentication functions in other networks.

NSSF 745 is responsible for selecting the appropriate network slice for UE 710 based on UE 710's subscription data and requested service. This may involve determining which slice or slices are best suited to meet the specific service requirements and UE 710's subscription profile. NSSF 745 is also responsible for enforcing policies related to network slice access, managing information about the network slices, and interacting with other core network functions to ensure that UE 710 is connected to the correct slice and that slice-specific rules are applied.

NEF 750 plays a role in securely exposing the capabilities of core network 705 to external applications and services. NEF 750 may perform functions such as providing standardized APIs for third-party services to access specific network capabilities or information and ensuring that the exposure of network capabilities and user data is managed securely and user privacy is maintained. NRF 755 acts as a central registry and discovery service for the network functions within core network 705. NRF 755 allows other network functions to register their services and discover the services provided by other network functions, maintains up-to-date information on the services offered by different network functions, supports load balancing and fault tolerance mechanisms within the network, and supports the scalability of the network.

UDM 760 is a central entity for managing subscriber data and authentication information. UDM 760 stores and manages subscription-specific information and is responsible for handling the authentication and authorization of users trying to access the network. Although not directly managing sessions, UDM 760 provides necessary information to other network functions, such as AMF 730 and SMF 735, to assist in session establishment and management based on the subscriber's data. UDM 760 also supports seamless service continuity and roaming by managing user identities and security information across different types of networks.

UDR 765 acts as a database (or multiple databases) for storing and managing structured subscriber data and service information. UDR 765 manages access to subscription data for other network functions such as AMF 730, SMF 735, and UDM 760. AF 770 is representative of external applications and services that may need to interact with core network 705 for various purposes. PCF 775 is responsible for policy management, which involves creating and enforcing policy rules for network behavior and user data transmission.

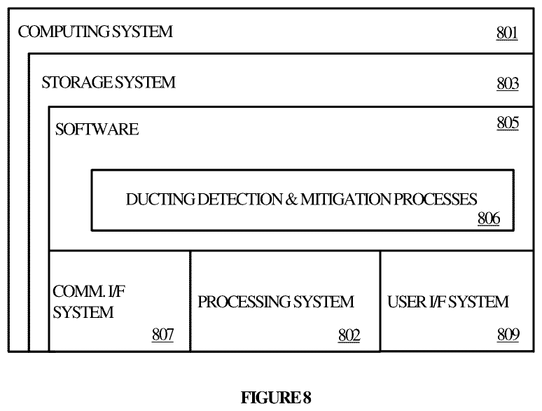

FIG. 8 illustrates computing system 801, which is representative of any system or collection of systems in which the various processes, programs, services, and scenarios disclosed herein may be implemented. Examples of computing system 801 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements ducting detection and mitigation processes 806, which is representative of the ducting detection, classification, and mitigation processes discussed with respect to the preceding Figures, such as process 500 and process 600. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including ducting detection and mitigation processes 806) may be implemented in program instructions and among other functions may, when executed by processing system 802, direct processing system 802 to operate as described with respect to the various operational scenarios, sequences, and processes illustrated herein. For example, software 805 may include program instructions for implementing the ducting detecting, classification, and mitigation processes in a 4G and/or 5G wireless communication environment as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to perform the 4G and 5G network processes described herein. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary, etc.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a wireless communication network, the method comprising:
receiving at least one received interference power (RIP) value collected at a base station of the wireless communication network;
identifying a ducting intensity by comparing the at least one RIP value collected at the base station to a baseline RIP value;
comparing the ducting intensity with at least one threshold to determine whether to apply ducting mitigation parameters in the wireless communication network; and
if the ducting intensity exceeds the at least one threshold, applying at least one ducting mitigation strategy in the wireless communication network.

2. The method of claim 1, wherein the at least one RIP value comprises a cell average uplink RIP value.

3. The method of claim 2, wherein receiving the at least one RIP value collected at the base station comprises receiving one RIP value for each physical resource block (PRB) of a plurality of PRBs in a frequency band of the wireless communication network.

4. The method of claim 3, wherein the frequency band of the wireless communication network is a n41 band and the wireless communication network is a Fifth Generation (5G) cellular communication network.

5. The method of claim 4, wherein receiving one RIP value for each of the plurality of PRBs in the frequency band comprises receiving one RIP value for every PRB in a 100 MHz bandwidth of the n41 band.

6. The method of claim 3, further comprising aggregating each RIP value for each PRB of the plurality of PRBs into two or more aggregated values, wherein each aggregated value of the two or more aggregated values comprises an average of two or more of the RIP values for the plurality of PRBs.

7. The method of claim 6, wherein identifying the ducting intensity comprises comparing the aggregated values to the baseline RIP value.

8. The method of claim 1, wherein applying the at least one ducting mitigation strategy comprises modifying at least one parameter that affects which frequency band user equipment uses to connect to the base station.

9. The method of claim 1, further comprising classifying the ducting intensity into a particular classification of two or more classifications based at least in part on the ducting intensity and the at least one RIP value.

10. The method of claim 9, wherein:
each classification of the two or more classifications is associated with a different ducting mitigation strategy; and
applying the at least one ducting mitigation strategy comprises applying one ducting mitigation strategy of different ducting mitigation strategies that corresponds to the particular classification.

11. One or more non-transitory computer-readable storage media having program instructions stored thereon, wherein the program instructions, when executed by a computing system, direct the computing system to perform operations, the operations comprising:
receiving at least one received interference power (RIP) value collected at a base station of a wireless communication network;
identifying a ducting intensity by comparing the at least one RIP value collected at the base station to a baseline RIP value;
comparing the ducting intensity with at least one threshold to determine whether to apply ducting mitigation parameters in the wireless communication network; and
if the ducting intensity exceeds the at least one threshold, applying at least one ducting mitigation strategy in the wireless communication network.

12. The one or more non-transitory computer-readable storage media of claim 11, wherein the at least one RIP value comprises a cell average uplink RIP value.

13. The one or more non-transitory computer-readable storage media of claim 12, wherein receiving the at least one RIP value collected at the base station comprises receiving one RIP value for each physical resource block (PRB) of a plurality of PRBs in a frequency band of the wireless communication network.

14. The one or more non-transitory computer-readable storage media of claim 13, wherein the frequency band of the wireless communication network is a n41 band and the wireless communication network is a Fifth Generation (5G) cellular communication network.

15. The one or more non-transitory computer-readable storage media of claim 14, wherein receiving one RIP value for each of the plurality of PRBs in the frequency band comprises receiving one RIP value for every PRB in a 100 MHz bandwidth of the n41 band.

16. The one or more non-transitory computer-readable storage media of claim 13, the operations further comprising aggregating each RIP value for each PRB of the plurality of PRBs into two or more aggregated values, wherein each aggregated value of the two or more aggregated values comprises an average of two or more of the RIP values for the plurality of PRBs.

17. The one or more non-transitory computer-readable storage media of claim 16, wherein identifying the ducting intensity comprises comparing the aggregated values to the baseline RIP value.

18. The one or more non-transitory computer-readable storage media of claim 11, wherein applying the at least one ducting mitigation strategy comprises modifying at least one parameter that affects which frequency band user equipment uses to connect to the base station.

19. The one or more non-transitory computer-readable storage media of claim 11, further comprising classifying the ducting intensity into one of two or more classifications based at least in part on the ducting intensity and the at least one RIP value.

20. A system comprising:
one or more computer-readable storage media;
a processing system operatively coupled with the one or more computer-readable storage media; and
program instructions stored on the one or more computer-readable storage media, wherein the program instructions, when read and executed by the processing system, direct the processing system to at least:
receive at least one received interference power (RIP) value collected at a base station of a wireless communication network;
identify a ducting intensity by comparing the at least one RIP value collected at the base station to a baseline RIP value;
compare the ducting intensity with at least one threshold to determine whether to apply ducting mitigation parameters in the wireless communication network; and
if the ducting intensity exceeds the at least one threshold, apply at least one ducting mitigation strategy in the wireless communication network.
